(19) United States
(12) Patent Application Publication
(10) Pub. No.: US 2025/0154918 A1
(43) Pub. Date: May 15, 2025

(54) METHOD AND DEVICE FOR MONITORING A SECONDARY AIR SUPPLY IN AN INTERNAL COMBUSTION ENGINE

(71) Applicant: Robert Bosch GmbH, Stuttgart (DE)

(72) Inventors: Alexandre Wagner, Stuttgart (DE); Michael Bachner, Stuttgart (DE)

(21) Appl. No.: 18/911,942

(22) Filed: Oct. 10, 2024

(30) Foreign Application Priority Data
Nov. 10, 2023 (DE) 10 2023 211 192.6

(51) Int. Cl. F02D 41/22; F02M 23/00

(52) U.S. Cl. CPC F02D 41/22; F02M 23/00

(57) ABSTRACT

A method for monitoring a secondary air supply in an internal combustion engine. The method includes: a) determining, with the aid of a throttle equation and according to a pressure in the secondary air supply, a first secondary air mass flow in relation to the effective throttle area; b) determining a second secondary air mass flow based on a measured exhaust gas lambda value and taking into account a primary air mass flow of the internal combustion engine and a supplied fuel mass flow; c) deriving an effective throttle area from the first secondary air mass flow determined in step a) and the second secondary air mass flow determined in step b); d) monitoring the effective throttle area obtained in this way using at least one specified threshold value.

### CROSS REFERENCE

The present application claims the benefit under 35 U.S.C. § 119 of German Patent Application No. DE 10 2023 211 192.6 filed on Nov. 10, 2023, which is expressly incorporated herein by reference in its entirety.

### FIELD

The present invention relates to a method for monitoring a secondary air supply in an internal combustion engine. The present invention also relates to a diagnostic system for a secondary air supply in an internal combustion engine.

### BACKGROUND INFORMATION

In recent years, emissions from modern combustion engines have been significantly reduced through numerous measures. The constant tightening of existing exhaust emission limits and the regulation of additional pollutant components such as NH₃ in the various markets is leading to increasing complexity in exhaust aftertreatment systems.

One measure to increase the temperature in the exhaust gas aftertreatment system is secondary air injection. An external air mass flow is introduced into the exhaust manifold at the exhaust valves of the engine, which reacts exothermically in conjunction with a rich combustion chamber lambda on the hot surfaces of the manifold and turbocharger.

For determining the target value for secondary air injection, a target value for combustion chamber lambda (raw emissions from the internal combustion engine) along with exhaust gas lambda (catalytic converter capability) can be specified, for example. The required secondary air volume, for example, can then be determined from the ratio of the two lambda target values and the current exhaust gas mass flow.

In the diagnosis of the secondary air system, the actual secondary air mass flow determined from the measured pressure in the secondary air system is monitored. When actively conveying a secondary air mass flow against a closed secondary air valve, the pressure in the secondary air system must increase and the actual secondary air mass flow modeled therefrom should be reduced due to the reduced purge gradient. If the secondary air valve is open, a positive secondary air mass flow is expected according to the purge gradient.

However, the currently used diagnosis of the secondary air system is sometimes not sensitive enough to reliably recognize small leaks in the secondary air system as errors, for example.

It is an object of the present invention to provide a method for monitoring and a diagnostic system for a secondary air supply, which allows for a more reliable diagnosis of errors in the secondary air system and/or which improves the diagnosis of any errors in the secondary air system.

### SUMMARY

According to the present invention, a method for monitoring a secondary air supply in an internal combustion engine and a corresponding diagnostic system are provided.

Example embodiments of the present invention are disclosed herein.

According to a first aspect of the present invention, a method for monitoring a secondary air supply in an internal combustion engine is provided, wherein the internal combustion engine comprises the secondary air supply, a device for determining a pressure in the secondary air supply and an exhaust gas lambda probe for determining a current exhaust gas lambda value. According to an example embodiment of the present invention, the method comprises the following steps:
a) determining, with the aid of a throttle equation and according to a pressure in the secondary air supply, a first secondary air mass flow in relation to the effective throttle area;
b) determining a second secondary air mass flow based on the measured exhaust gas lambda value and taking into account a primary air mass flow of the internal combustion engine and a supplied fuel mass flow;
c) deriving an effective throttle area from the first secondary air mass flow determined in step a) and the second secondary air mass flow determined in step b),
d) monitoring the effective throttle area obtained in this way using at least one specified threshold value.

In the method for monitoring the secondary air supply according to an example embodiment of the present invention, the secondary air mass flow is determined in two different ways. On the one hand, by means of a throttle equation based on the pressure ratios in the exhaust system, a first secondary air mass in relation to the effective throttle area is determined. On the other hand, a second secondary air mass flow is determined on the basis of the measured exhaust gas lambda value. An effective throttle area is derived from these two secondary air mass flows ascertained in different ways. Based on this effective throttle area, it is possible to track whether the first secondary air mass flow and the second secondary air mass flow are in a consistent ratio to one another.

Therefore, the effective throttle area obtained in this way is suitable for diagnosing the secondary air system. By means of at least one specified threshold value, it can be monitored whether the effective throttle area is within an expected range. If the effective throttle area leaves the expected range, it could be concluded, for example, that there is a malfunction in the secondary air system, such as a leak. Monitoring the effective throttle area allows for precise monitoring of the secondary air system during operation and early recognition of malfunctions.

In addition, the present invention relates to a diagnostic system for a secondary air supply in an internal combustion engine, wherein the internal combustion engine comprises: the secondary air supply for supplying secondary air, a device for determining the pressure in the secondary air supply, an exhaust gas lambda probe for determining a current exhaust gas lambda value, and an evaluation device. According to an example embodiment of the present invention, the evaluation device is designed:
a) to determine a first secondary air mass flow in relation to the effective throttle area with the aid of a throttle equation and according to a pressure in the secondary air supply;
b) to determine a second secondary air mass flow based on the measured exhaust gas lambda value and taking into account the primary air mass flow of the internal combustion engine and the supplied fuel mass flow;
C) to derive an effective throttle area from the first secondary air mass flow determined in step a) and the second secondary air mass flow determined in step b);
d) to monitor the effective throttle area obtained in this way using at least one specified threshold value.

It is advantageous if the first secondary air mass flow is determined in step a) by means of the throttle equation which relates the first secondary air mass flow to the pressure in the secondary air supply and the effective throttle area.

Preferably, the derivation of the effective throttle area in step c) is effected with the aid of a mass flow balance according to an exhaust gas lambda value.

Further preferably, the derivation of the effective throttle area in step c) is effected taking into account the temporal dynamics of the exhaust gas lambda probe.

According to a preferred embodiment of the present invention, the derivation of the effective throttle area in step c) is effected using the recursive least mean square (LMS) method or the recursive normalized least mean square (NLMS) method. The use of such recursive methods allows for an exact determination of the effective throttle area.

Preferably, the difference between the secondary air mass flow derived from the pressure and the secondary air mass flow derived from the exhaust gas lambda value is used as the error term of the recursive least mean square (LMS) method or the recursive normalized least mean square (NLMS) method.

According to a preferred embodiment of the present invention, a leak is recognized for monitoring in the event that the effective throttle area is greater than a specified first threshold value.

According to a preferred embodiment of the present invention, a jamming or clogging of the secondary air valve is recognized in the event that the effective throttle area is smaller than a specified second threshold value.

According to a further aspect of the present invention, a diagnostic system is provided for a secondary air supply in an internal combustion engine, wherein the internal combustion engine comprises:
the secondary air supply for supplying secondary air,
a device for determining the pressure in the secondary air supply,
an exhaust gas lambda probe for determining a current exhaust gas lambda value,
an evaluation device that is designed
   a) to determine a first secondary air mass flow in relation to the effective throttle area with the aid of a throttle equation and according to a pressure in the secondary air supply;
   b) to determine a second secondary air mass flow based on the measured exhaust gas lambda value and taking into account the primary air mass flow of the internal combustion engine and the supplied fuel mass flow;
   c) to derive an effective throttle area from the first secondary air mass flow determined in step a) and the second secondary air mass flow determined in step b);
   d) to monitor the effective throttle area obtained in this way using at least one specified threshold value.

### BRIEF DESCRIPTION OF THE DRAWINGS

Example embodiments of the present invention are explained in more detail below with reference to the figures.

FIG. 1 shows an overview representation of an exhaust system.

FIG. 2 shows a physical model of the secondary air supply.

FIG. 3 shows a schematic representation of an estimation algorithm for ascertaining the effective throttle area, according to an example embodiment of the present invention.

### DETAILED DESCRIPTION OF EXAMPLE EMBODIMENTS

One measure to increase the temperature in the exhaust gas aftertreatment system is secondary air injection. An external air mass flow is introduced into the exhaust manifold at the exhaust valves of the engine, which reacts exothermically in conjunction with a rich combustion chamber lambda on the hot surfaces of the manifold and turbocharger.

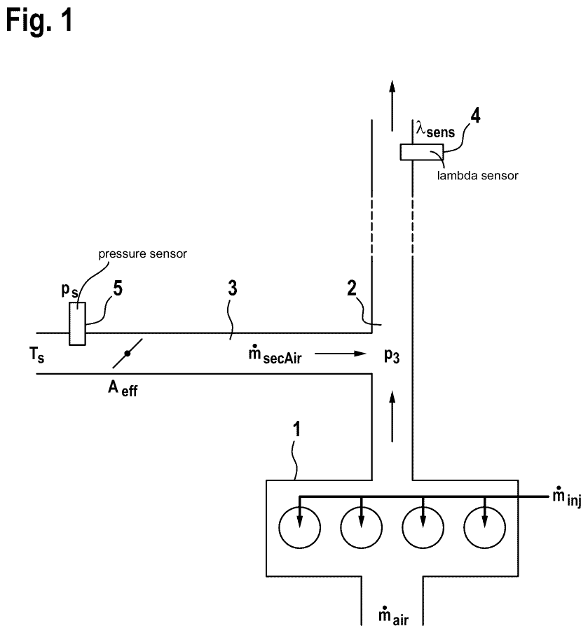

The diagnostic method and diagnostic system for a secondary air system described below is based on a physical model that describes the secondary air supply. This model is illustrated below based on FIG. 1. FIG. 1 shows an internal combustion engine 1 together with an exhaust gas duct 2 and a secondary air supply 3. In the combustion chambers of the internal combustion engine 1, the supplied fuel mass flow \dot{m}ᵢₙⱼ is partially reacted with the supplied primary air mass flow \dot{m}ₐᵢᵣ. A secondary air mass flow \dot{m}_{secAir} is supplied to the exhaust gas mass flow in the exhaust gas duct 2 via the secondary air supply 3, wherein the unburned fuel in the exhaust gas duct 2 reacts exothermically with the supplied secondary air. An exhaust gas lambda sensor 4 is arranged in the exhaust gas duct 2, which exhaust gas lambda sensor is designed to determine the exhaust gas lambda value λₛₑₙₛ.

The secondary air supply 3 can be regarded as a throttle. A pressure sensor 5 is arranged in the secondary air supply 3, which pressure sensor is designed to determine the pressure pₛ in the secondary air supply 3. The secondary air mass flow \dot{m}_{secAir} is set based on the pressure difference between the modeled pressure p₃ in the exhaust gas duct 2 and the measured pressure pₛ in the secondary air supply 3 and can be described by an effective throttle area A_{eff} (referred to as effective opening cross-section), which is also drawn in FIG. 1.

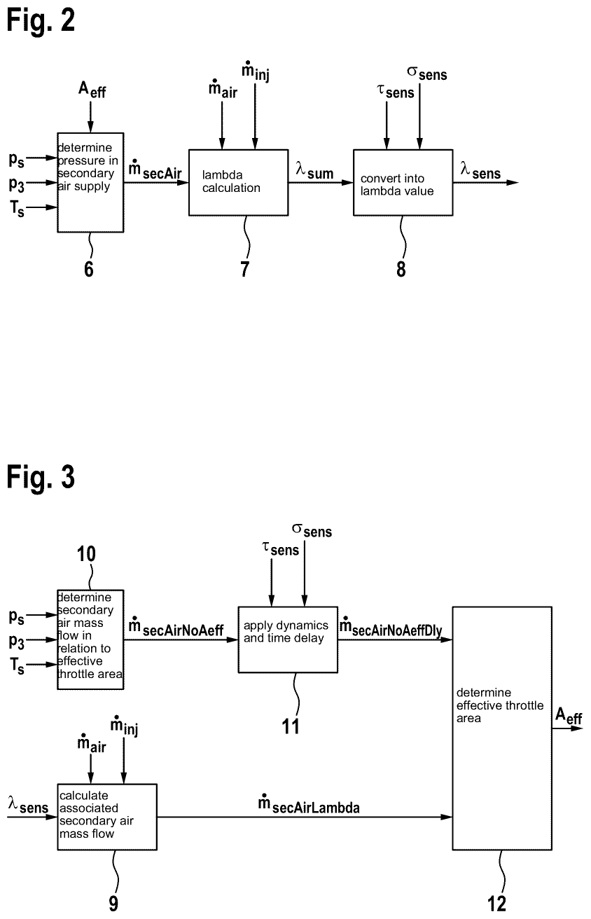

The physical model mentioned above describes the relationship between the pressure pₛ in the secondary air supply 3 and the measured exhaust gas lambda value λₛₑₙₛ. This physical model is shown schematically in FIG. 2. Since the secondary air supply 3 can be represented as a throttle, in step 6, based on the pressure pₛ in the secondary air supply 3, the temperature Tₛ in the secondary air supply 3, the pressure p₃ in the exhaust gas duct 2 and the effective throttle area A_{eff}, the secondary air mass flow \dot{m}_{secAir} can be determined by means of a throttle equation. Based on the secondary air mass flow \dot{m}_{secAir} determined in this way, the primary air mass flow \dot{m}ₐᵢᵣ and the fuel mass flow \dot{m}ᵢₙⱼ, a lambda calculation 7 can subsequently be carried out in order to obtain a calculated lambda value λₛᵤₘ. This calculated lambda value λₛᵤₘ is then converted into a lambda value by applying a lambda dynamic 8, i.e. by taking into account the dynamics and the dead time of the exhaust gas lambda sensor 4, which are represented by the parameters τₛₑₙₛ and σₛₑₙₛ, into the actual exhaust gas lambda value λₛₑₙₛ(t) measured by the exhaust gas lambda sensor 4.

The calculations on which the physical model shown in FIG. 2 is based are shown below. The secondary air mass flow \dot{m}_{secAir} through the secondary air supply 3, which can be described as a throttle, can be represented by means of the throttle equation

$${\dot{m}}_{secAir} = {A}_{eff} \cdot {p}_{S} \cdot \sqrt{\frac{2}{R \cdot {T}_{S}}} \cdot Ψ ( {Π}_{S} )$$

where

$${Π}_{S} = \frac{{p}_{3}}{{p}_{S}}$$

denotes the pressure ratio between the pressure p₃ in the exhaust gas duct 2 and the pressure pₛ in the secondary air supply 3. Here, A_{eff} is the effective throttle area, pₛ is the pressure in the secondary air supply 3 and Tₛ is the temperature of the secondary air. Ψ(Πₛ) denotes a flow function according to the pressure ratio Πₛ

$$Ψ ( Π ) = \{ \begin{matrix}{Ψ}_{crit} \cdot \sqrt{2 \cdot \frac{1 - Π}{1 - {Π}_{crit}} - {( \frac{1 - Π}{1 - {Π}_{crit}} )}^{2}} , falls {Π}_{crit} \leq Π \leq 1 \\ {Ψ}_{crit} , falls 0 \leq Π \leq {Π}_{crit}\end{matrix}$$

where Π_{crit}=0.528 and Ψ_{crit}=0.484.

In the following lambda calculation 7 of the model shown in FIG. 2, based on the total air supplied (\dot{m}_{secAir}+\dot{m}ₐᵢᵣ), the calculated lambda λₛᵤₘ is calculated as

$${λ}_{sum} = \frac{{\dot{m}}_{air} + {\dot{m}}_{secAir}}{{λ}_{sto} \cdot {\dot{m}}_{inj}}$$

where λₛₜₒ=14.7 denotes the stoichiometric ratio upon the reaction of fuel with air. In the following lambda dynamics 8, the dynamic behavior of the lambda path is modeled by means of the following differential equation, taking into account the dynamics and dead time of the exhaust gas lambda sensor 4:

$${τ}_{sens} \frac{d {λ}_{sens} ( t )}{dt} + {λ}_{sens} ( t ) = {λ}_{sum} ( t - {σ}_{sens} )$$

where λₛᵤₘ denotes the lambda ascertained by calculation, τₛₑₙₛ and σₛₑₙₛ denote the parameters used for modeling the lambda dynamics and λₛₑₙₛ(t) denotes the exhaust gas lambda value detected by the exhaust gas lambda sensor 4.

On the basis of the model equations for the physical model shown in FIG. 2, an estimation algorithm for the effective throttle area A_{eff} is now constructed. The procedure for ascertaining the effective throttle area A_{eff} is illustrated schematically in FIG. 3. The aim is to ascertain the effective throttle area A_{eff} and to monitor the secondary air supply using the ascertained effective throttle area A_{eff} in order to be able to recognize and diagnose any problems with the secondary air supply as early as possible.

Initially, the lower path of the diagram shown in FIG. 3 for estimating the effective throttle area A_{eff} is described. In the lower path, the associated secondary air mass flow \dot{m}_{secAirLambda} is calculated based on the exhaust gas lambda value λₛₑₙₛ(t), which is measured by the exhaust gas lambda sensor 4, by means of an inverted lambda calculation 9 and using the primary air mass flow \dot{m}ₐᵢᵣ and the fuel mass flow \dot{m}ᵢₙⱼ. For determining \dot{m}_{secAirLambda}, the formula

$${\dot{m}}_{secAirLambda} = {λ}_{sto} \cdot {\dot{m}}_{inj} \cdot {λ}_{sens} - {\dot{m}}_{air}$$

is used, which results from the definition of lambda, where λₛₜₒ denotes the stoichiometric ratio of air to fuel, \dot{m}ᵢₙⱼ denotes the supplied fuel mass flow, λₛₑₙₛ denotes the measured exhaust gas lambda value and \dot{m}ₐᵢᵣ denotes the primary air mass flow.

In the upper path of the diagram shown in FIG. 3, the secondary air mass flow \dot{m}_{secAirNoAeff}, in relation to the effective throttle area A_{eff}, is determined in the first step 10 by means of the throttle equation (without effective throttle area)

$${\dot{m}}_{secAirNoAeff} = {p}_{S} \cdot \sqrt{\frac{2}{R \cdot {T}_{S}}} \cdot Ψ ( {Π}_{S} ) .$$

Here, Πₛ denotes the pressure ratio

$${Π}_{S} = \frac{{p}_{3}}{{p}_{S}} ,$$

pₛ denotes the pressure in the secondary air supply 3, Tₛ denotes the temperature in the secondary air supply 3 and p₃ denotes the pressure in the exhaust gas duct 2.

By means of the following lambda dynamics 11, the dynamics and time delay of the exhaust gas lambda sensor 4, which are described by the parameters τₛₑₙₛ and σₛₑₙₛ, are applied to the secondary air mass flow \dot{m}_{secAirNoAeff}, which is ascertained in this way in relation to the effective throttle area. In this way, a time-dependent secondary air mass flow \dot{m}_{secAirNoAeffDly}(t) is obtained in relation to the effective throttle area, which is brought into phase with the secondary air mass flow \dot{m}_{secAirLambda} determined on the basis of the measured exhaust gas lambda value λₛₑₙₛ(t). The following differential equation is used to apply lambda dynamics to the time-dependent secondary air mass flow \dot{m}_{secAirNoAeff}(t) in relation to the effective throttle area

$${τ}_{sens} \frac{d {\dot{m}}_{secAirNoAeffDly} ( t )}{dt} + {\dot{m}}_{secAirNoAeffDly} ( t ) = {\dot{m}}_{secAirNoAeff} ( t - {σ}_{sens} )$$

Next, the effective throttle area A_{eff} is determined based on the secondary air mass flow \dot{m}_{secAirLambda} determined in the lower path and the secondary air mass flow \dot{m}_{secAirNoAeff} determined in the upper path and in relation to the effective throttle area. This step is drawn in FIG. 3 as step 12.

In order to determine the effective throttle area A_{eff}, the variable \dot{m}_{secAirLambda} (t) could be divided by the variable \dot{m}_{secAirNoAeff} (t). However, it has been shown that calculating quotients in this way can lead to inaccurate results. In particular, if the secondary air mass flow becomes very small or even approaches zero, inaccurate values could be obtained for the effective throttle area A_{eff}.

For this reason, it is advantageous to use a recursive least square algorithm to recursively determine the effective throttle area A_{eff}, in the present case for example an LMS (least mean square) algorithm or further preferably an NLMS (normalized least mean square) algorithm. The starting point for the recursive determination of the effective throttle area is the equation

$${\dot{m}}_{secAirMod , k} = {\dot{m}}_{secAirNoAeffDly , k} \cdot {A}_{effEst , k}$$

which establishes a relationship between the secondary air mass flow \dot{m}_{secAirMod,k} determined by means of the throttle equation via the effective throttle area \dot{m}_{secAirNoAeffDly,k} and the secondary air mass flow determined by means of the exhaust lambda sensor 4.

In the case of using an LMS (least mean square) algorithm as the adaptation algorithm, the derivation results in

$$\frac{K \cdot w}{{w}^{T} \cdot w} \cdot error$$

as the adaptation factor and

$$\frac{K}{w} \cdot error$$

error in the scalar case, where w denotes the regressor, K is a proportionality constant, and error denotes the error. In the present case, the regressor w is the secondary air mass flow obtained from the throttle equation without effective throttle area \dot{m}_{secAirNoAeffDly,k}. However, if the secondary air mass flow approaches zero, the LMS algorithm, for example, may have the problem that the adaptation factor becomes infinite.

In order to avoid this problem, it is advantageous to use an NLMS (normalized least mean square) algorithm in the implementation. The adaptation factor for the NLSM algorithm is

$$\frac{K \cdot w}{1 + {w}^{T} \cdot w} \cdot error ,$$

which results in

$$\frac{K \cdot w}{1 + {w}^{2}} \cdot error$$

in the scalar case. For the recursive estimation of the effective throttle area, using a modified NLMS algorithm results in

$${A}_{effEst , k} =$$

$$= {A}_{effEst , k - 1} + \frac{{K}_{id} \cdot {\dot{m}}_{secAirNoAeffDly , k}}{1 + {K}_{id} \cdot {\dot{m}}_{secAirNoAeffDly , k}^{2}} \cdot ( {\dot{m}}_{secAirLambda , k} - {\dot{m}}_{secAirMod , k} )$$

K_{id} is a setting parameter for the estimation speed. This difference equation is repeated at each time step. The estimated value A_{effEst,k} obtained in this way is then compared with preset threshold values. This means that a leak can be recognized if A_{effEst,k} becomes too large. In addition, jamming or clogging of the secondary air valve can be recognized if A_{effEst,k} becomes too small.

The present invention can also be extended to other exhaust gas topologies. For example, if there are a plurality of valves in the secondary air supply, it would be possible to use a different reference variable for modeling the throttle instead of pₛ, such as the exhaust back pressure or the boost pressure. Modeled variables can also be used instead of pressure sensors. The features disclosed herein may be of importance both individually and in any combination for the realization of the present invention in its various embodiments.

What is claimed is:

1. A method for monitoring a secondary air supply in an internal combustion engine, wherein the internal combustion engine includes the secondary air supply, a device configured to determine a pressure in the secondary air supply, and an exhaust gas lambda probe configured to determine a current exhaust gas lambda value, wherein the method comprises the following steps:
a) determining, using a throttle equation and according to a pressure in the secondary air supply, a first secondary air mass flow in relation to an effective throttle area;
b) determining a second secondary air mass flow based on a measured exhaust gas lambda value and taking into account a primary air mass flow of the internal combustion engine and a supplied fuel mass flow;
c) deriving the effective throttle area from the first secondary air mass flow determined in step a) and the second secondary air mass flow determined in step b); and
d) monitoring the effective throttle area derived in step c) using at least one specified threshold value.

2. The method according to claim 1, wherein the first secondary air mass flow is determined in step a) using the throttle equation, which relates the first secondary air mass flow to the pressure in the secondary air supply and the effective throttle area.

3. The method according to claim 1, wherein the derivation of the effective throttle area in step c) is effected using a mass flow balance according to an exhaust gas lambda value.

4. The method according to claim 1, wherein the derivation of the effective throttle area in step c) is effected taking into account temporal dynamics of the exhaust gas lambda probe.

5. The method according to claim 1, wherein the derivation of the effective throttle area in step c) is effected using a recursive least mean square (LMS) method or a recursive normalized least mean square (NLMS) method.

6. The method according to claim 5, wherein a difference between the secondary air mass flow derived from the pressure and the secondary air mass flow derived from the exhaust gas lambda value is used as an error term of the recursive least mean square (LMS) method or the recursive normalized least mean square (NLMS) method.

7. The method according to claim 1, wherein a leak is recognized in the event that the effective throttle area is greater than a specified first threshold value.

8. The method according to claim 1, wherein a jamming or clogging of the secondary air valve is recognized in the event that the effective throttle area is smaller than a specified second threshold value.

9. A diagnostic system for a secondary air supply in an internal combustion engine, wherein the internal combustion engine comprises:
the secondary air supply configured to supply secondary air;
a device configured to determine a pressure in the secondary air supply;
an exhaust gas lambda probe configured to determine a current exhaust gas lambda value; and
an evaluation device configured to:
a) determine a first secondary air mass flow in relation to an effective throttle area using a throttle equation and according to the pressure in the secondary air supply;
b) determine a second secondary air mass flow based on a measured exhaust gas lambda value and taking into account a primary air mass flow of the internal combustion engine and a supplied fuel mass flow;
c) derive the effective throttle area from the first secondary air mass flow determined in step a) and the second secondary air mass flow determined in step b); and
d) monitor the effective throttle area derived in step c) using at least one specified threshold value.

10. An exhaust system of an internal combustion engine, comprising:
a diagnostic system for a secondary air supply in an internal combustion engine, wherein the internal combustion engine includes:
the secondary air supply configured to supply secondary air;
a device configured to determine a pressure in the secondary air supply;
an exhaust gas lambda probe configured to determine a current exhaust gas lambda value; and
an evaluation device configured to:
a) determine a first secondary air mass flow in relation to an effective throttle area using a throttle equation and according to the pressure in the secondary air supply;
b) determine a second secondary air mass flow based on a measured exhaust gas lambda value and taking into account a primary air mass flow of the internal combustion engine and a supplied fuel mass flow;
c) derive the effective throttle area from the first secondary air mass flow determined in step a) and the second secondary air mass flow determined in step b); and
d) monitor the effective throttle area derived in step c) using at least one specified threshold value.

11. A non-transitory machine-readable storage medium on which store stored commands for monitoring a secondary air supply in an internal combustion engine, wherein the internal combustion engine includes the secondary air supply, a device configured to determine a pressure in the secondary air supply, and an exhaust gas lambda probe configured to determine a current exhaust gas lambda value, the commands, when executed by at least one data processor, causing the at least one data processor to perform the following steps:
a) determining, using a throttle equation and according to a pressure in the secondary air supply, a first secondary air mass flow in relation to an effective throttle area;
b) determining a second secondary air mass flow based on a measured exhaust gas lambda value and taking into account a primary air mass flow of the internal combustion engine and a supplied fuel mass flow;
c) deriving the effective throttle area from the first secondary air mass flow determined in step a) and the second secondary air mass flow determined in step b); and
d) monitoring the effective throttle area derived in step c) using at least one specified threshold value.
